(19) United States
(12) Patent Application Publication
(10) Pub. No.: US 2007/0119058 A1
(43) Pub. Date: May 31, 2007

(54) Butter slicer and spreader

(75) Inventors: Neal Ho, San Francisco, CA (US); David Chan, Scarborough (CA)

Correspondence Address: BANNER & WITCOFF, LTD., 1100 13th STREET, N.W., SUITE 1200, WASHINGTON, DC, 20005-4051, US

(73) Assignee: Browne & Co., Ltd., Markham (CA)

(21) Appl. No.: 11/287,487

(22) Filed: Nov. 28, 2005

(51) Int. Cl. A01D 1/00

(52) U.S. Cl. 30/279.6

(57) ABSTRACT

A hand implement for slicing and spreading a food spread comprising a handle and a substantially planar spreader part extending longitudinally from the handle. The spreader part defines a longitudinal opening and has a longitudinal cutting element projecting into and downwardly of the opening wherein the cutting element is adapted to direct the food spread to a spreading surface of the spreader part.

### FIELD OF THE INVENTION

The invention relates to culinary utensils and more particularly to a hand implement for slicing and spreading butter or other food spreads such as margarine, soft cheese, or the like.

### BACKGROUND OF THE INVENTION

Devices for addressing the problem of how to spread cold and/or cubed butter onto a surface such as fresh or toasted bread, or the like, without tearing the surface, are known in the art. For instance, Japanese Patent Application JP2004121773A2 to Yasuhiro, H. (hereinafter “Yasuhiro”) provides a butter knife comprising a spatula part with an upturned end and a cutting part for thinly shaving a ribbon of butter and spreading the shaved butter onto bread or the like.

Yasuhiro shows the cutting part located in an opening at an opposing end of the spatula part relative to the point of attachment of the handle. The cutting part and opening are parallel to each other and are perpendicular to the longitudinal axis of the butter knife. Adjacent to the cutting part and opening, distal to the handle, is a blade bed part that is inclined from the flat surface of the spatula part and which has an inwardly curved part at its tapered end. By pushing the spreader across a block of butter such that the blade bed part is parallel with the horizontal plane of the butter, the cutting part thinly slices a ribbon of butter. The butter collects on the upper surface of the spatula part, and is then placed onto a slice of bread or the like. The lower surface of the spatula part can then be used to spread the butter onto the bread.

In use, the motion to shave, place, and spread the butter is awkward. It is desirable to have a slicer/spreader for butter and other food spreads that allows for greater ease of use, and wherein the spreader may be further adapted to facilitate spreading the food spread. These and other desirable characteristics will become apparent from a review of the following disclosure and description below.

### DISCLOSURE OF THE INVENTION

There is provided a hand implement for slicing and spreading butter or other food spreads such as margarine, soft cheese, or the like. The implement comprises a handle and a substantially planar spreader part extending longitudinally from the handle. The spreader part defines a longitudinal opening and has a longitudinal cutting element projecting into and downwardly of the opening. The longitudinal cutting element is adapted to direct the food spread to a spreading surface of the spreader part.

In one aspect, the spreader part is made of stainless steel.

In another aspect, the spreader part comprises a supporting framework and a silicone coating.

In another aspect, the supporting framework of the spreader part is made of stainless steel.

In yet another aspect, there is also provided a method for spreading a food spread.

### BRIEF DESCRIPTION OF THE DRAWINGS

In order that the invention may be readily understood, preferred embodiments of the invention will be described by way of examples, with reference to the accompanying drawings wherein:

FIG. 1 is an isometric top view of an implement for slicing and spreading butter in accordance with one embodiment of the invention;

FIG. 2 is an isometric bottom view of the implement of FIG. 1;

FIG. 3A is bottom view of the implement shown in FIG. 1;

FIG. 3B is a side view of the implement shown in FIG. 3A;

FIG. 3C is a top view of the implement shown in FIG. 3A;

FIG. 4 is an isometric cross section of the slicer/spreader part of the implement taken along line 4-4 of FIG. 3C;

FIG. 5A shows one embodiment of the implement of the present invention showing the slicer/spreader part without any silicone molding;

FIG. 5B shows the silicone molding of one embodiment of the present invention without the slicer/spreader part and handle; and

FIG. 6A is a top view of the slicer/spreader implement of the present invention; and

FIG. 6B is a view of the slicer/spreader implement of the present invention in use slicing butter in the direction of arrow A shown in FIG. 6A.

### DETAILED DESCRIPTION OF THE PREFERRED EMBODIMENTS

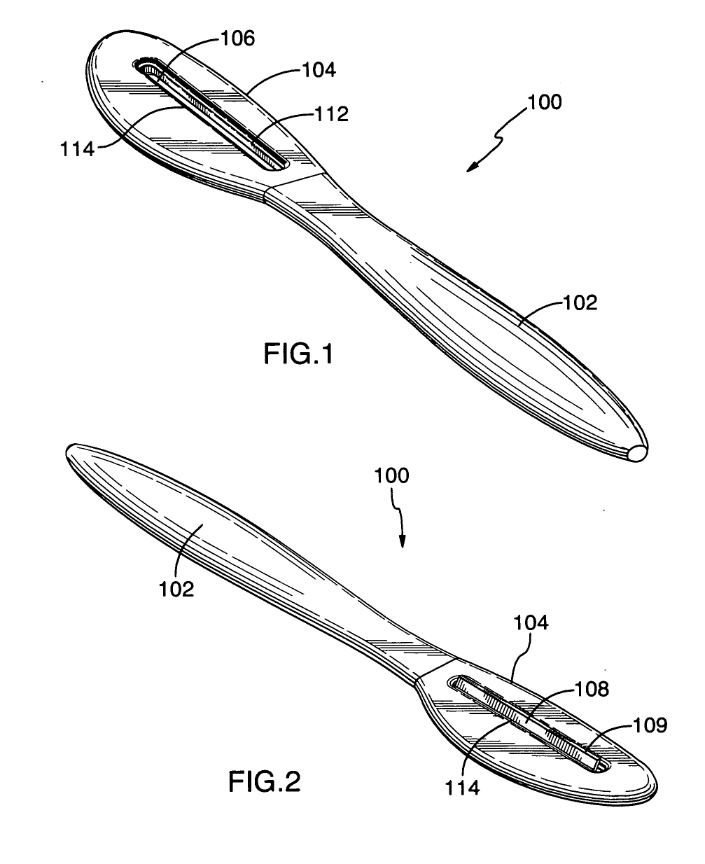

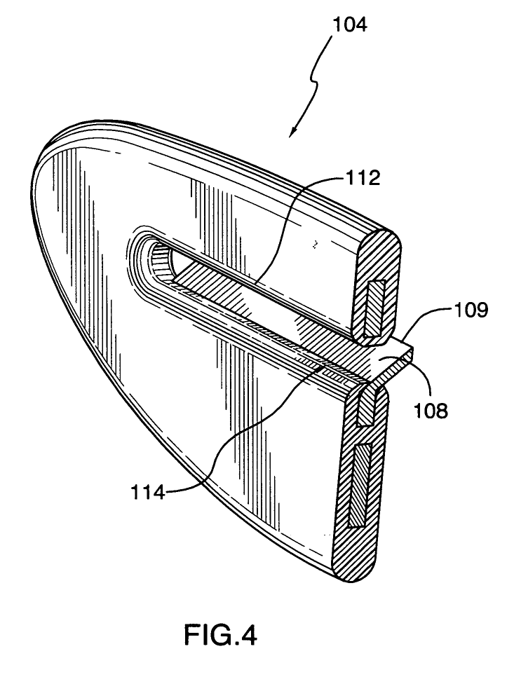

The present invention relates to a hand implement for slicing and spreading butter, or other food spreads. While the embodiments illustrated in FIGS. 1-6 are described with reference to slicing and spreading butter, it will be understood by those skilled in the art that the invention may also be used with other food spreads such as margarine, soft cheese, or the like.

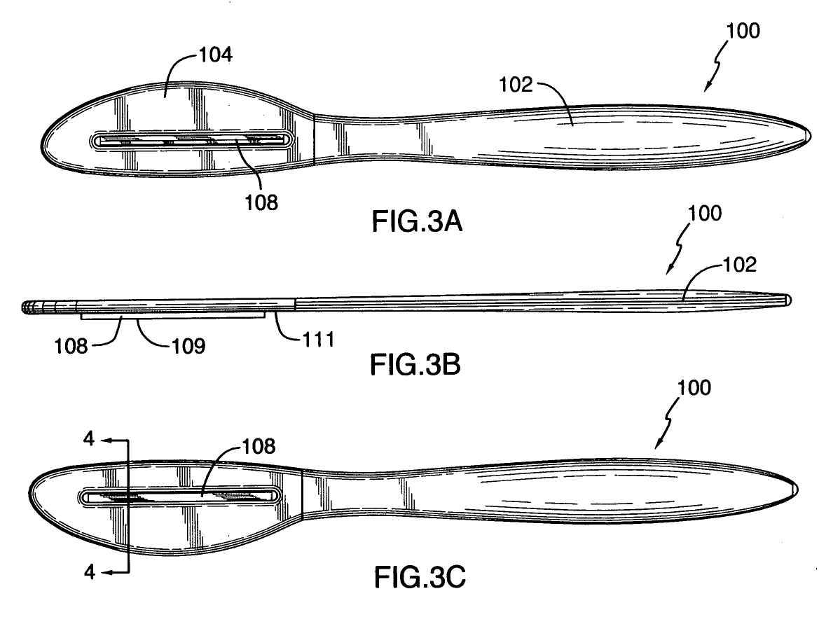

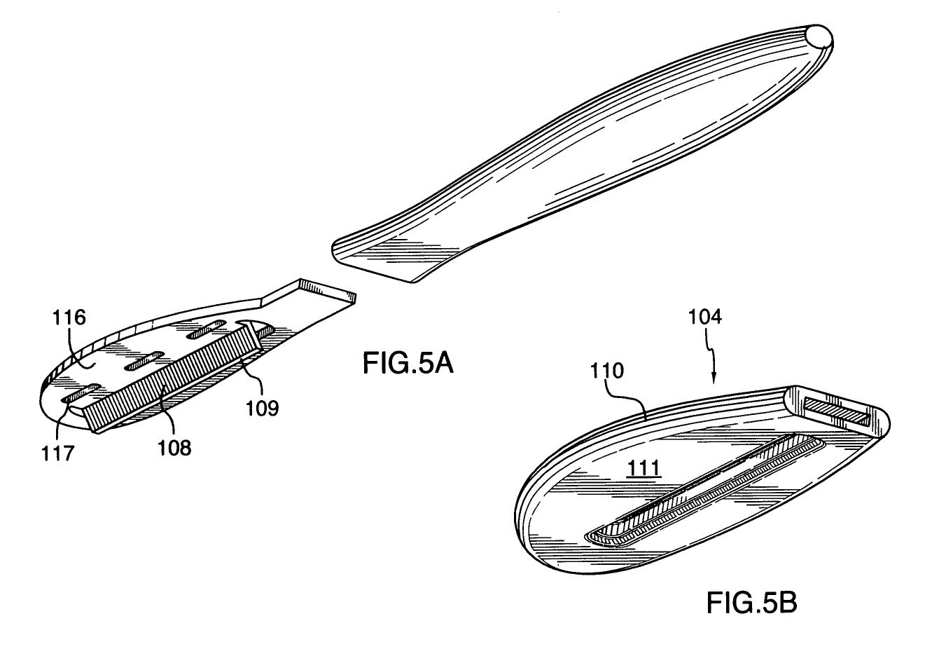

Slicer/spreader 100 comprises a handle 102 and a spreader part 104, wherein the latter is substantially planar as shown in FIGS. 1-6. The spreader part 104 extends longitudinally from the handle 102 and defines an elongated longitudinal opening 106, wherein the long sides 112 and 114 of the opening are oriented substantially parallel to the longitudinal axis of the slicer/spreader 100. Projecting from long side 114 into the longitudinal opening 106 and toward an undersurface 111 of the spreader part 104 is a longitudinal cutting element 108. The longitudinal cutting element 108 has a cutting edge 109 that extends parallel with the long sides 112 and 114 of the longitudinal opening 106. The longitudinal cutting element 108 is inclined towards the cutting or slicing direction A, as is shown in FIGS. 3 and 5.

The longitudinal cutting element 108, and handle 102 are manufactured from rigid materials, such as metal or plastics. In a preferred embodiment, longitudinal cutting element 108, and handle 102 are manufactured from stainless steel, which is advantageously food friendly.

In the embodiment illustrated, and as shown clearly in FIGS. 5A-5B, the spreader part 104 of the slicer/spreader 100 comprises a rigid supporting framework 116 that is surrounded by a silicone coating 110. In a preferred embodiment the rigid supporting framework 116 is argon welded to the handle 102. However, it will be understood that the two pieces may be joined together by other means known in the art or may be manufactured as one piece.

The supporting framework 116 defines holes 117 through which the silicone extends. In a preferred embodiment, the supporting framework 116 is manufactured from stainless steel. The silicone coating 110 provides greater flexibility to the spreader part 104 than if the spreader part 104 were manufactured solely from a stiffer material such as metal or hard plastic, thereby facilitating spreading the sliced butter. Furthermore, the silicone coating 110 extends beyond the immediate boundaries of the supporting framework 116 on the side of the spreader part 104 from which the longitudinal cutting element 108 projects. As can be clearly seen in FIG. 3B, the side profile of the silicone coating 110 and the handle 102 is substantially flat. This embodiment provides for still greater flexibility in the spreader part 104.

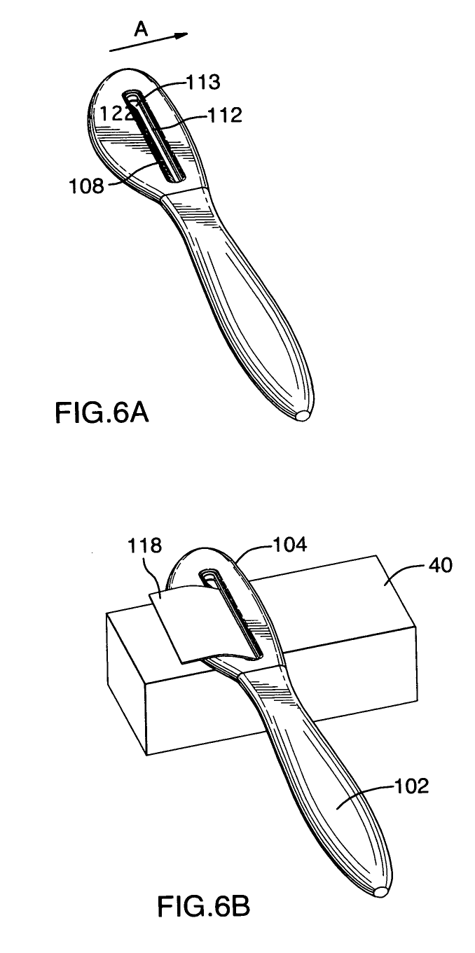

With reference to FIG. 5B, but being equally applicable to the embodiment shown in FIGS. 1-4, the cutting edge 109 of the longitudinal cutting element 108 lies at a distance from the substantially planar undersurface 111 of the spreader part 104 corresponding to the desired butter slice thickness. Provided between the cutting edge 109 and the long side 112 is a slot 113, shown clearly in FIG. 6A, through which the butter slice 118, shown in FIG. 6B, passes and glides onto the upper surface of the cutting edge and subsequently the upper surface 122 of the spreader part 104.

Thus, when the slicer/spreader 100 is in operation, as illustrated in FIG. 6B, the handle 102 is utilized to draw the implement across a block of butter, indicated at numeral 40, such that the spreader part 104 is roughly in parallel with the surface of the butter, in the direction A as indicated in FIG. 6A. The longitudinal cutting element 108 slices the butter via its cutting edge 109, and the butter is thinly sliced and deposited onto the upper surface 122 of the spreader part 104. The spreader part 104 is then used to spread the collected butter slice 118 onto fresh or toasted bread, or the like, not shown. As the slicing action, of the slicer/spreader 100 deposits the sliced butter directly onto the surface 122 to be used for spreading the butter, this provides for ease of use of the implement.

As illustrated in FIGS. 1-6, in a preferred embodiment of the invention the butter slicer/spreader is advantageously knife-shaped. Thus, in this embodiment, the spreading surface and spreading action of the butter slicer/spreader are similar to those of a conventional butter knife, further providing for ease of use of the hand implement.

The butter slicer/spreader of the present application also easily fits in cutlery drawers and other storage spaces, providing for ease of storage of the hand implement.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

All publications, patents and patent applications referred to herein are incorporated by reference in their entirety to the same extent as if each individual publication, patent or patent application was specifically and individually indicated to be incorporated by reference in its entirety.

1. A hand implement for slicing and spreading a food spread comprising:
a handle, and
a substantially planar spreader part extending longitudinally from the handle, the spreader part defining a longitudinal opening and having a longitudinal cutting element projecting into and downwardly of said opening,
wherein said cutting element is adapted to direct the food spread to a spreading surface of the spreader part.

2. A hand implement as claimed in claim 1, wherein the spreader part is made of stainless steel.

3. A hand implement as claimed in claim 1, wherein the spreader part comprises a supporting framework and a silicone coating.

4. A hand implement as claimed in claim 3, wherein the supporting framework is made of stainless steel.

5. A hand implement as claimed in claim 3, wherein the supporting framework comprises the cutting element.

6. A hand implement as claimed in claim 6, wherein the supporting framework and the handle are unitary.

7. A method for spreading a food spread using a hand implement having a handle and a spreader part extending from the handle, the spreader part having a spreading surface and an opening and a cutting element projecting into and downwardly from the opening away from the spreading surface, the method comprising the steps of:
drawing the hand implement across a surface of the food spread, such that the spreader part is roughly in parallel with the surface of the food spread and a cutting edge of said cutting element slices said food spread;
turning said hand implement to locate the food spread slice adjacent the surface on which it is to be spread; and
spreading the food spread slice onto a surface using the spreading surface of the spreader part of the hand implement.

8. The method as claimed in claim 7 wherein the food spread is butter.
